(19) United States
(12) Patent Application Publication
(10) Pub. No.: US 2023/0374962 A1
(43) Pub. Date: Nov. 23, 2023

(54) Fuel Pump

(71) Applicant: Hitachi Astemo, Ltd., Hitachinaka-shi, Ibaraki (JP)

(72) Inventors: Yuto ISHIZUKA, Hitachinaka-shi, Ibaraki (JP); Yasuhisa UCHIYAMA, Hitachinaka-shi, Ibaraki (JP); Masamichi YAGAI, Hitachinaka-shi, Ibaraki (JP)

(21) Appl. No.: 18/029,938

(22) PCT Filed: Aug. 27, 2021
(86) PCT No.: PCT/JP2021/031532

§ 371 Date: Apr. 3, 2023

(30) Foreign Application Priority Data
Oct. 30, 2020 (JP) 2020-182058

(51) Int. Cl. F02M 59/48

(52) U.S. Cl. CPC F02M 59/48; F02M 59/027

(57) ABSTRACT

A fuel pump includes a plunger that reciprocates, a retainer having a mounting portion attached to a lower end portion of the plunger, and a spring that biases the plunger via the retainer. The mounting portion has an engagement portion that is engaged with a constricted portion formed at the lower end portion of the plunger. A diameter of a circle formed by a corner portion of the engagement portion and an inner peripheral wall of the spring is smaller than a diameter of the lower end portion of the plunger.

### TECHNICAL FIELD

The present invention relates to a fuel pump for an internal combustion engine of an automobile.

### BACKGROUND ART

In a direct injection type engine that directly injects fuel into a combustion chamber of an engine (internal combustion engine) of an automobile or the like, a high-pressure fuel pump for increasing pressure of fuel is widely used. A conventional technique of the high-pressure fuel pump is described, for example, PTL 1.

The high-pressure fuel pump described in PTL 1 includes a plunger that moves up and down by rotational motion of a cam attached to a cam shaft of an engine. A retainer is attached to a lower end portion of the plunger. Then, the plunger is biased to the cam side by a spring via the retainer.

### CITATION LIST

### Patent Literature

PTL 1: WO 2004/63559 A

### SUMMARY OF INVENTION

### Technical Problem

However, in the conventional high-pressure fuel pump, there has been a possibility that, before the retainer is accommodated in a tappet, when the high-pressure fuel pump is attached to a fuel pump attachment portion provided in an internal combustion engine, the plunger and the spring become eccentric, and the retainer falls off the plunger.

In view of the above problem, an object of the present invention is to provide a fuel pump capable of preventing a retainer from falling off a plunger.

### Solution to Problem

In order to solve the above problem and achieve the object of the present invention, a fuel pump of the present invention includes a plunger that reciprocates, a retainer having a mounting portion attached to a lower end portion of the plunger, and a spring that biases the plunger via the retainer. The mounting portion of the retainer has an engagement portion that is engaged with a constricted portion formed at the lower end portion of the plunger. A diameter of a circle formed by a corner portion of the engagement portion and an inner peripheral wall of the spring is smaller than a diameter of the lower end portion of the plunger.

### Advantageous Effects of Invention

According to the fuel pump having the above configuration, it is possible to prevent the retainer from falling off the plunger.

Note that, an object, a configuration, and an advantageous effect other than those described above will be clarified in description of an embodiment described below.

### BRIEF DESCRIPTION OF DRAWINGS

FIG. 1 is an overall configuration diagram of a fuel supply system using a high-pressure fuel pump according to an embodiment of the present invention.

FIG. 2 is a longitudinal cross-sectional view (part 1) of the high-pressure fuel pump according to the embodiment of the present invention.

FIG. 3 is a horizontal cross-sectional view of the high-pressure fuel pump according to the embodiment of the present invention as viewed from above.

FIG. 4 is a longitudinal cross-sectional view (part 2) of the high-pressure fuel pump according to the embodiment of the present invention.

FIG. 5 is an enlarged cross-sectional view illustrating a lower end portion of a plunger and a retainer in the high-pressure fuel pump according to the embodiment of the present invention.

FIG. 6 is a perspective view illustrating the retainer of the high-pressure fuel pump according to the embodiment of the present invention.

FIG. 7 is a plan view illustrating the retainer of the high-pressure fuel pump according to the embodiment of the present invention.

FIG. 8 is a front view of the retainer of the high-pressure fuel pump according to the embodiment of the present invention as viewed from an insertion portion.

FIG. 9 is a front view illustrating a state in which the retainer of the high-pressure fuel pump according to the embodiment of the present invention is attached to the plunger.

FIG. 10 is an explanatory view illustrating a state in which the retainer of the high-pressure fuel pump according to the embodiment of the present invention is attached to the plunger.

FIG. 11 is a cross-sectional view illustrating a relationship between a gap between the retainer, the plunger, and a spring in the high-pressure fuel pump according to the embodiment of the present invention.

FIG. 12 illustrates a state in which the retainer is eccentric in the high-pressure fuel pump according to the embodiment of the present invention, in which FIG. 12A is a plan view and FIG. 12B is a cross-sectional view.

FIG. 13 is a longitudinal cross-sectional view illustrating another example of the high-pressure fuel pump according to the embodiment of the present invention.

### DESCRIPTION OF EMBODIMENTS

### 1. Embodiment of High-Pressure Fuel Pump

Hereinafter, a high-pressure fuel pump according to an embodiment of the present invention will be described. Note that, in the diagrams, the same members are denoted by the same reference numerals.

### [Fuel Supply System]

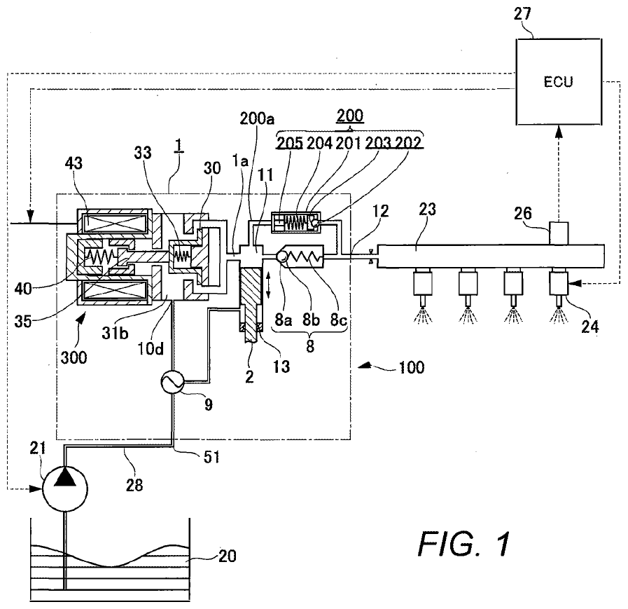

First, a fuel supply system using the high-pressure fuel pump according to the present embodiment will be described with reference to FIG. 1.

FIG. 1 is an overall configuration diagram of the fuel supply system using the high-pressure fuel pump according to the present embodiment of the present invention.

As illustrated in FIG. 1, the fuel supply system includes a high-pressure fuel pump 100, an engine control unit (ECU) 27, a fuel tank 20, a common rail 23, and a plurality of injectors 24. A component of the high-pressure fuel pump 100 is integrally incorporated in a pump body 1.

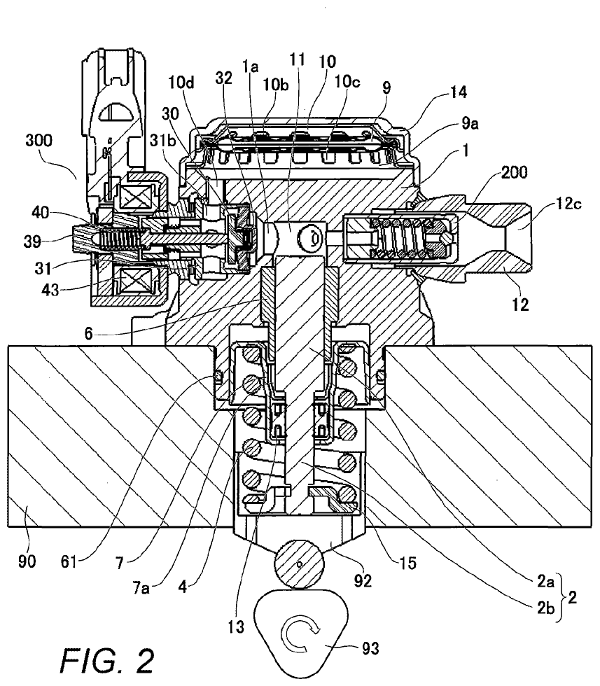

Fuel in the fuel tank 20 is pumped up by a feed pump 21 that is driven based on a signal from the ECU 27. Pumped up fuel is pressurized to an appropriate pressure by a pressure regulator (not illustrated) and sent to a low-pressure fuel suction port 10a (see FIG. 2) provided in a suction joint 51 of the high-pressure fuel pump 100 through a fuel pipe 28.

The high-pressure fuel pump 100 pressurizes fuel supplied from the fuel tank 20 and pressure-feeds the fuel to the common rail 23. A plurality of the injectors 24 and a fuel pressure sensor 26 are mounted on the common rail 23. A plurality of the injectors 24 are mounted in accordance with the number of cylinders (combustion chambers), and inject fuel according to drive current output from the ECU 27. The fuel supply system of the present embodiment is what is called a direct injection engine system in which the injector 24 directly injects fuel into a cylinder of an engine.

The fuel pressure sensor 26 outputs detected pressure data to the ECU 27. The ECU 27 calculates an appropriate injection fuel amount (target injection fuel length), an appropriate fuel pressure (target fuel pressure), and the like based on an engine state quantity (for example, a crank rotation angle, a throttle opening, an engine speed, a fuel pressure, and the like) obtained from various sensors.

Further, the ECU 27 controls driving of the high-pressure fuel pump 100 and a plurality of the injectors 24 based on a calculation result of a fuel pressure (target fuel pressure) and the like. That is, the ECU 27 includes a pump control unit that controls the high-pressure fuel pump 100 and an injector control unit that controls the injector 24.

The high-pressure fuel pump 100 includes a plunger 2, a pressure pulsation reduction mechanism 9, an electromagnetic suction valve mechanism 300 which is a capacity varying mechanism, a relief valve mechanism 200, and a discharge valve mechanism 8. Fuel flowing in from the low-pressure fuel suction port 10a reaches a suction port 31b of the electromagnetic suction valve mechanism 300 via the pressure pulsation reduction mechanism 9 and a low-pressure fuel suction passage 10d.

Fuel flowing into the electromagnetic suction valve mechanism 300 passes through a suction valve 30, flows through a suction passage 1a formed in the pump body 1, and then flows into a pressurizing chamber 11. The pump body 1 slidably holds the plunger 2. The plunger 2 reciprocates when power is transmitted by a cam 93 (see FIG. 2) of an engine. One end portion of the plunger 2 is inserted into the pressurizing chamber 11 so that the volume of the pressurizing chamber 11 is increased or decreased.

In the pressurizing chamber 11, fuel is sucked from the electromagnetic suction valve mechanism 300 in a downward stroke of the plunger 2, and fuel is pressurized in an upward stroke of the plunger 2. When a fuel pressure in the pressurizing chamber 11 exceeds a set value, a discharge valve mechanism 8 is opened, and high-pressure fuel is pressure-fed to the common rail 23 through a fuel discharge port of a discharge joint 12. Fuel discharge by the high-pressure fuel pump 100 is operated by opening and closing of the electromagnetic suction valve mechanism 300. Then, opening and closing of the electromagnetic suction valve mechanism 300 is controlled by the ECU 27.

In a case where an abnormally high pressure is generated in the common rail 23 or the like due to a failure of the injector 24 or the like, when a differential pressure between a fuel discharge port (see FIG. 2) of the discharge joint 12 communicating with the common rail 23 and the pressurizing chamber 11 becomes equal to or more than a valve opening pressure (predetermined value) of the relief valve mechanism 200, the relief valve mechanism 200 opens. By the above, fuel having an abnormally high pressure is returned to the pressurizing chamber 11 through the relief valve mechanism 200. As a result, piping such as the common rail 23 is protected.

### [High-Pressure Fuel Pump]

Next, a configuration of the high-pressure fuel pump 100 will be described with reference to FIGS. 2 to 4.

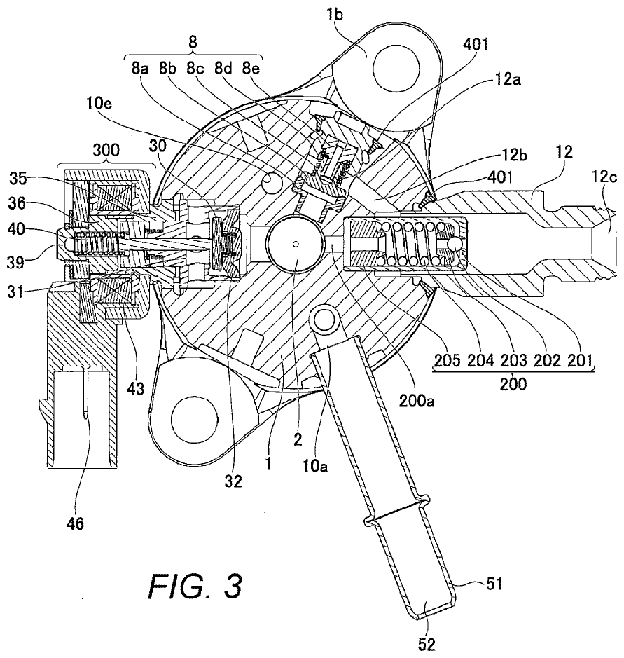

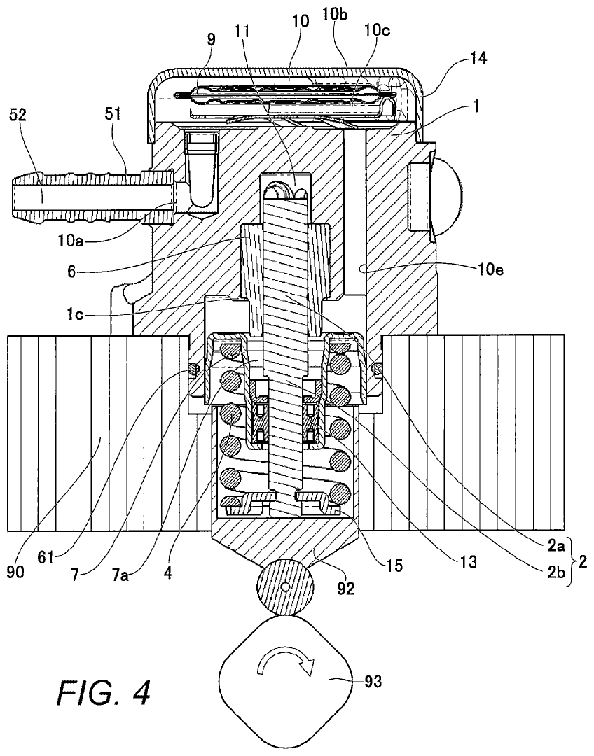

FIG. 2 is a longitudinal cross-sectional view (part 1) of the high-pressure fuel pump 100 as viewed in a cross section orthogonal to the horizontal direction. FIG. 3 is a horizontal cross-sectional view of the high-pressure fuel pump 100 as viewed in a cross section orthogonal to the vertical direction. FIG. 4 is a longitudinal cross-sectional view (part 2) of the high-pressure fuel pump 100 as viewed in a cross section orthogonal to the horizontal direction.

As illustrated in FIGS. 2 and 3, the pump body 1 of the high-pressure fuel pump 100 is provided with the suction passage 1a described above and an attachment flange 1e (see FIG. 3). The attachment flange 1e is in close contact with a fuel pump attachment portion 90 of an engine (internal combustion engine) and is fixed by a plurality of bolts (screws) (not illustrated). That is, the high-pressure fuel pump 100 is fixed to the fuel pump attachment portion 90 by the attachment flange 1e.

As illustrated in FIG. 2, an O-ring 61 is interposed between the fuel pump attachment portion 90 and the pump body 1. The O-ring 61 prevents engine oil from leaking to the outside of an engine (internal combustion engine) through between the fuel pump attachment portion 90 and the pump body 1.

Further, a cylinder 6 that guides reciprocating motion of the plunger 2 is attached to the pump body 1 of the high-pressure fuel pump 100. The cylinder 6 is formed in a tubular shape, and is press-fitted into the pump body 1 on the outer peripheral side of the cylinder 6. The pump body 1 and the cylinder 6 form the pressurizing chamber 11 together with the electromagnetic suction valve mechanism 300, the plunger 2, and the discharge valve mechanism 8 (see FIG. 3).

The pump body 1 is provided with a fixing portion 1c that engages with a center portion in an axial direction of the cylinder 6. The fixing portion 1c is formed to be plastically deformable. The fixing portion 1c presses the cylinder 6 upward (upward in FIG. 2). An upper end surface (one end surface) of the cylinder 6 abuts on the pump body 1. As a result, fuel pressurized in the pressurizing chamber 11 does not leak from between the upper end surface of the cylinder 6 and the pump body 1.

A tappet 92 is provided at a lower end of the plunger 2. The tappet 92 converts rotational motion of the cam 93 attached to a cam shaft of an engine into vertical motion and transmits the vertical motion to the plunger 2. The plunger 2 is biased to the cam 93 side by a spring 4 via a retainer 15, and is pressure-bonded to the tappet 92. The plunger 2 reciprocates together with the tappet 92 to change the volume of the pressurizing chamber 11. Note that a detailed configuration of the retainer 15 will be described later.

Further, a seal holder 7 is arranged between the cylinder 6 and the retainer 15. The seal holder 7 is formed in a tubular shape into which the plunger 2 is inserted. An auxiliary chamber 7a is formed at an upper end portion of the seal holder 7 on the cylinder 6 side. On the other hand, a lower end portion of the seal holder 7 on the retainer 15 side holds a plunger seal 13.

The plunger seal 13 is slidably in contact with an outer periphery of the plunger 2. When the plunger 2 reciprocates, the plunger seal 13 seals fuel in the auxiliary chamber 7a so that fuel in the auxiliary chamber 7a does not flow into an engine. Further, the plunger seal 13 prevents lubricating oil (including engine oil) that lubricates a sliding portion in an engine from flowing into the pump body 1.

In FIG. 2, the plunger 2 reciprocates in the vertical direction. When the plunger 2 moves downward, the volume of the pressurizing chamber 11 increases, and when the plunger 2 moves upward, the volume of the pressurizing chamber 11 decreases. That is, the plunger 2 is arranged to reciprocate in a direction of enlarging and reducing the volume of the pressurizing chamber 11.

The plunger 2 has a large diameter portion 2a and a small diameter portion 2b. When the plunger 2 reciprocates, the large diameter portion 2a and the small diameter portion 2b are located in the auxiliary chamber 7a. Therefore, the volume of the auxiliary chamber 7a increases or decreases by the reciprocation of the plunger 2.

The auxiliary chamber 7a communicates with a low-pressure fuel chamber 10 through a fuel passage 10e (see FIGS. 3 and 4). When the plunger 2 moves downward, fuel flows from the auxiliary chamber 7a to the low-pressure fuel chamber 10, and when the plunger 2 moves upward, fuel flows from the low-pressure fuel chamber 10 to the auxiliary chamber 7a. By the above, a fuel flow rate into and out of a pump in a suction stroke or a return stroke of the high-pressure fuel pump 100 can be reduced, and pressure pulsation generated inside the high-pressure fuel pump 100 can be reduced.

Further, the pump body 1 is provided with the relief valve mechanism 200 communicating with the pressurizing chamber 11. The relief valve mechanism 200 includes a seat member 201, a relief valve 202, a relief valve holder 203, a relief spring 204, and a spring support member 205.

The seat member 201 includes the relief spring 204 and forms a relief valve chamber. One end portion of the relief spring 204 is in contact with the spring support member 205, and the other end portion is in contact with the relief valve holder 203. The relief valve holder 203 is engaged with the relief valve 202. A biasing force of the relief spring 204 acts on the relief valve 202 via the relief valve holder 203.

The relief valve 202 is pressed by a biasing force of the relief spring 204 to close a fuel passage of the seat member 201. The fuel passage of the seat member 201 communicates with a discharge passage 12b (see FIG. 3). Movement of fuel between the pressurizing chamber 11 (upstream side) and the seat member 201 (downstream side) is blocked as the relief valve 202 is in contact (close contact) with the seat member 201.

When pressure in the common rail 23 or a member beyond the common rail increases, fuel on the seat member 201 side presses the relief valve 202 to move the relief valve 202 against a biasing force of the relief spring 204. As a result, the relief valve 202 is opened, and fuel in the discharge passage 12b returns to the pressurizing chamber 11 through a fuel passage 200a of the seat member 201. Therefore, pressure for opening the relief valve 202 is determined by the biasing force of the relief spring 204.

Note that the relief valve mechanism 200 of the present embodiment communicates with the pressurizing chamber 11, but is not limited to this configuration, and may communicate with a low-pressure passage, for example.

As illustrated in FIGS. 3 and 4, the suction joint 51 is attached to a side surface portion of the pump body 1. The suction joint 51 is connected to the fuel pipe 28 (see FIG. 1) through which fuel supplied from the fuel tank 20 passes. Fuel in the fuel tank 20 is supplied from the suction joint 51 to the inside of the high-pressure fuel pump 100.

The suction joint 51 has a suction flow path 52 communicating with the low-pressure fuel suction port 10a connected to the fuel pipe 28. Fuel that passes through the suction flow path 52 of the suction joint 51 reaches the suction port 31b (see FIG. 2) of the electromagnetic suction valve mechanism 300 via the pressure pulsation reduction mechanism 9 and the low-pressure fuel suction passage 10d (see FIG. 2) provided in the low-pressure fuel chamber 10. A suction filter is arranged in a fuel passage communicating with the suction flow path 52 of the suction joint 51. The suction filter removes a foreign substance present in fuel and prevents the foreign substance from entering the high-pressure fuel pump 100.

As illustrated in FIGS. 2 and 4, the pump body 1 of the high-pressure fuel pump 100 is provided with a low-pressure fuel chamber (damper chamber) 10. The low-pressure fuel chamber 10 is covered with a damper cover 14. The damper cover 14 is formed in, for example, a tubular shape (cup shape) with one side closed.

As illustrated in FIG. 2, the low-pressure fuel chamber 10 is vertically divided into a damper upper portion 10b and a damper lower portion 10c by the pressure pulsation reduction mechanism 9. When fuel flowing into the pressurizing chamber 11 is returned to the low-pressure fuel suction passage 10d (see FIG. 2) through the electromagnetic suction valve mechanism 300 in a valve open state again, pressure pulsation is generated in the low-pressure fuel chamber 10. The pressure pulsation reduction mechanism 9 reduces spreading of pressure pulsation generated in the high-pressure fuel pump 100 to the fuel pipe 28.

Next, the electromagnetic suction valve mechanism 300 will be described.

The electromagnetic suction valve mechanism 300 is inserted into a lateral hole formed in the pump body 1. The electromagnetic suction valve mechanism 300 includes a suction valve seat 31 press-fitted into the lateral hole formed in the pump body 1, the suction valve 30, a suction valve biasing spring 33, a rod 35, a movable core 36, a rod biasing spring 40, and an electromagnetic coil (solenoid) 43.

The suction valve seat 31 is formed in a tubular shape, and a seating portion is provided on an inner peripheral portion. Further, the suction port 31b that reaches an inner peripheral portion from an outer peripheral portion is formed in the suction valve seat 31. The suction port 31b communicates with the low-pressure fuel suction passage 10d in the low-pressure fuel chamber 10 described above.

A stopper 32 facing the seating portion of the suction valve seat 31 is arranged in the lateral hole formed in the pump body 1. Then, the suction valve 30 is arranged between the stopper 32 and the seating portion. Further, the suction valve biasing spring 33 is interposed between the stopper 32 and the suction valve 30. The suction valve biasing spring 33 biases the suction valve 30 to the seating portion side.

The suction valve 30 abuts on the seating portion to close a communicating portion between the suction port 31b and the pressurizing chamber 11. By the above, the electromagnetic suction valve mechanism 300 is in a valve closed state. On the other hand, the suction valve 30 abuts on the stopper 32 to open the communicating portion between the suction port 31b and the pressurizing chamber 11. By the above, the electromagnetic suction valve mechanism 300 is in a valve open state.

The rod 35 penetrates the suction valve seat 31. One end of the rod 35 abuts on the suction valve 30. The rod biasing spring 40 biases the suction valve 30 in a valve opening direction which is the stopper 32 side via the rod 35. One end of the rod biasing spring 40 is engaged with a flange portion provided on an outer peripheral portion of the rod 35. The other end of the rod biasing spring 40 is engaged with a magnetic core 39 arranged so as to surround the rod biasing spring 40.

The movable core 36 faces an end surface of the magnetic core 39. The movable core 36 is engaged with a flange portion provided on an outer peripheral portion of the rod 35. Further, one end of an on-off valve biasing spring abuts on the side of the movable core 36 opposite to the magnetic core 39. The other end of the on-off valve biasing spring abuts on the suction valve seat 31. Further, the on-off valve biasing spring biases the movable core 36 to the side of the flange portion of the rod 35. A moving amount of the movable core 36 is set to be larger than a moving amount of the suction valve 30. By the above, the suction valve 30 can be reliably caused to abut (seated) on the seating portion, and the electromagnetic suction valve mechanism 300 can be reliably brought into a valve closed state.

The electromagnetic coil 43 is arranged around the magnetic core 39. A terminal member 46 is electrically connected to the electromagnetic coil 43, and current flows through the terminal member 46. In a non-energized state in which no current flows through the electromagnetic coil 43, the rod 35 is biased in a valve opening direction by a biasing force of the rod biasing spring 40, and presses the suction valve 30 in the valve opening direction. As a result, the suction valve 30 is separated from the seating portion and abuts on the stopper 32, and the electromagnetic suction valve mechanism 300 is in a valve open state. That is, the electromagnetic suction valve mechanism 300 is of a normal open type that opens in a non-energized state.

In a valve open state of the electromagnetic suction valve mechanism 300, fuel in the suction port 31b passes between the suction valve 30 and the seating portion, passes through a plurality of fuel passage holes (not illustrated) of the stopper 32 and the suction passage 1a, and flows into the pressurizing chamber 11. In the valve open state of the electromagnetic suction valve mechanism 300, the suction valve 30 comes into contact with the stopper 32, so that the position of the suction valve 30 in the valve opening direction is restricted. Then, in the valve open state of the electromagnetic suction valve mechanism 300, a gap existing between the suction valve 30 and the seating portion is a movable range of the suction valve 30, which is a valve opening stroke.

When a control signal from the ECU 27 is applied to the electromagnetic suction valve mechanism 300, current flows to the electromagnetic coil 43 via the terminal member 46. When current flows through the electromagnetic coil 43, the movable core 36 is attracted in a valve closing direction by a magnetic attraction force of the magnetic core 39 on a magnetic attraction surface.

When the movable core 36 is attracted to the magnetic core 39 and moves, the flange portion of the rod 35 is engaged with the movable core 36 and the rod 35 moves in the valve closing direction. The suction valve 30 moves in the valve opening direction (direction away from the seating portion) by a gap of the valve opening stroke along with the movement of the rod 35 to be in the valve open state, and fuel is supplied from the low-pressure fuel suction passage 10d to the pressurizing chamber 11.

Further, the suction valve 30 stops moving by colliding with the stopper 32 press-fitted and fixed in a housing of the electromagnetic suction valve mechanism 300. The rod 35 and the suction valve 30 are separate and independent structures. The suction valve 30 comes into contact with the seating portion of the suction valve seat 31 arranged on the suction side to close a flow path to the pressurizing chamber 11, and is separated from the seating portion of the suction valve seat 31 to open the flow path to the pressurizing chamber 11.

Next, the discharge valve mechanism 8 will be described. As illustrated in FIG. 3, the discharge valve mechanism 8 is connected to the outlet side of the pressurizing chamber 11. The discharge valve mechanism 8 includes a discharge valve seat member 8a and a discharge valve 8b that comes into contact with and is separated from the discharge valve seat member 8a. Further, the discharge valve mechanism 8 includes a discharge valve spring 8c that biases the discharge valve 8b to the discharge valve seat member 8a side, a plug 8d, and a discharge valve stopper 8e that determines a stroke (moving distance) of the discharge valve 8b.

The discharge valve seat member 8a, the discharge valve 8b, the discharge valve spring 8c, and the discharge valve stopper 8e are housed in a discharge valve chamber 12a formed in the pump body 1. The discharge valve chamber 12a is a substantially columnar space extending in the horizontal direction. One end of the discharge valve chamber 12a communicates with the pressurizing chamber 11 via a fuel passage. The other end of the discharge valve chamber 12a opens to a side surface of the pump body 1. The plug 8d is fixed to the other end portion of the discharge valve chamber 12a by welding, for example, at a welded portion 401. For this reason, an opening of the other end portion of the discharge valve chamber 12a is sealed by the plug 8d.

Further, the discharge joint 12 is joined to the pump body 1 by the welded portion 401. The discharge joint 12 has a fuel discharge port 12c. The fuel discharge port 12c communicates with the discharge valve chamber 12a via the discharge passage 12b extending in the horizontal direction inside the pump body 1. Further, the fuel discharge port 12c of the discharge joint 12 is connected to the common rail 23.

In a state where a fuel pressure of the pressurizing chamber 11 is lower than a fuel pressure of the discharge valve chamber 12a, the discharge valve 8b is pressed against the discharge valve seat member 8a by a differential pressure acting on the discharge valve 8b and a biasing force of the discharge valve spring 8c. As a result, the discharge valve mechanism 8 becomes in a valve closed state. On the other hand, when a fuel pressure in the pressurizing chamber 11 becomes larger than a fuel pressure in the discharge valve chamber 12a and a differential pressure acting on the discharge valve 8b becomes larger than a biasing force of the discharge valve spring 8c, the discharge valve 8b is pushed by fuel and separated from the discharge valve seat member 8a. As a result, the discharge valve mechanism 8 becomes in a valve open state.

When the discharge valve mechanism 8 performs on-off valve operation, fuel is taken into and out of the discharge valve chamber 12a. Then, fuel taken out from the discharge valve chamber 12a is discharged from the discharge valve mechanism 8 to the discharge passage 12b. As a result, high-pressure fuel in the pressurizing chamber 11 is discharged to the common rail 23 (see FIG. 1) through the discharge valve chamber 12a, the discharge passage 12b, and the fuel discharge port 12c of the discharge joint 12. With the above configuration, the discharge valve mechanism 8 functions as a check valve that restricts a flowing direction of fuel.

Note that a detailed configuration of the discharge valve spring 8c will be described later.

### [Operation of Fuel Pump]

Next, operation of the high-pressure fuel pump 100 according to the present embodiment will be described.

In a case where the plunger 2 illustrated in FIG. 1 moves down and the electromagnetic suction valve mechanism 300 is opened, fuel flows from the suction passage 1a into the pressurizing chamber 11. Hereinafter, a stroke in which the plunger 2 moves down is referred to as a suction stroke. On the other hand, in a case where the plunger 2 moves up and the electromagnetic suction valve mechanism 300 is closed, fuel in the pressurizing chamber 11 is increased in pressure, passes through the discharge valve mechanism 8, and is pressure-fed to the common rail 23 (see FIG. 1). Hereinafter, a stroke in which the plunger 2 moves up is referred to as a compression stroke.

As described above, when the electromagnetic suction valve mechanism 300 is closed during the compression stroke, fuel sucked into the pressurizing chamber 11 during the suction stroke is pressurized and discharged to the common rail 23 side. On the other hand, when the electromagnetic suction valve mechanism 300 is opened during the compression stroke, fuel in the pressurizing chamber 11 is pushed back to the suction passage 1a side and is not discharged to the common rail 23 side. As described above, discharge of fuel by the high-pressure fuel pump 100 is operated by opening and closing of the electromagnetic suction valve mechanism 300. Then, opening and closing of the electromagnetic suction valve mechanism 300 is controlled by the ECU 27.

In the suction stroke, the volume of the pressurizing chamber 11 increases, and a fuel pressure in the pressurizing chamber 11 decreases. In this suction stroke, when a fuel pressure in the pressurizing chamber 11 becomes lower than a pressure in the suction port 31b (see FIG. 2) and a biasing force due to a differential pressure between them exceeds a biasing force by the suction valve biasing spring 33, the suction valve 30 is separated from the seating portion, and the electromagnetic suction valve mechanism 300 becomes in a valve open state. As a result, fuel passes between the suction valve 30 and the seating portion, and flows into the pressurizing chamber 11 through a plurality of holes provided in the stopper 32.

The high-pressure fuel pump 100 makes a transition to the compression stroke after finishing the suction stroke. At this time, the electromagnetic coil 43 remains in the non-energized state, and no magnetic attraction force acts between the movable core 36 and the magnetic core 39. The rod biasing spring 40 is set to have a biasing force necessary and sufficient to maintain the suction valve 30 at a valve open position separated from the seating portion in the non-energized state.

In this state, when the plunger 2 moves upward, the rod 35 remains at the valve open position, so that the suction valve 30 biased by the rod 35 also remains at the valve open position. Therefore, the volume of the pressurizing chamber 11 decreases with the upward movement of the plunger 2, but in this state, fuel once sucked into the pressurizing chamber 11 is returned to the low-pressure fuel suction passage 10d through the electromagnetic suction valve mechanism 300 in the valve open state again, and pressure in the pressurizing chamber 11 does not increase. This stroke will be referred to as a return stroke.

In the return stroke, when a control signal from the ECU 27 (see FIG. 1) is applied to the electromagnetic suction valve mechanism 300, current flows to the electromagnetic coil 43 via the terminal member 46. When current flows to the electromagnetic coil 43, a magnetic attraction force acts on a magnetic attraction surfaces S of the magnetic core 39 and the movable core 36, and the movable core 36 is attracted to the magnetic core 39. Then, when the magnetic attraction force becomes larger than a biasing force of the rod biasing spring 40, the movable core 36 moves to the magnetic core 39 side against the biasing force of the rod biasing spring 40, and the rod 35 engaged with the movable core 36 moves in a direction away from the suction valve 30. As a result, the suction valve 30 is seated on the seating portion by a biasing force of the suction valve biasing spring 33 and a fluid force caused by fuel flowing into the low-pressure fuel suction passage 10d, and the electromagnetic suction valve mechanism 300 becomes in the valve closed state.

After the electromagnetic suction valve mechanism 300 is in the valve closed state, fuel in the pressurizing chamber 11 is pressurized as the plunger 2 moves up, and when the pressure becomes equal to or more than a pressure of the fuel discharge port 12c, the fuel passes through the discharge valve mechanism 8 and is discharged to the common rail 23 (see FIG. 1). This stroke will be referred to as a discharge stroke. That is, the compression stroke between the bottom dead center and the top dead center of the plunger 2 includes the return stroke and the discharge stroke. Then, an amount of high-pressure fuel to be discharged can be controlled as a timing of energizing the electromagnetic coil 43 of the electromagnetic suction valve mechanism 300 is controlled.

If the timing of energizing the electromagnetic coil 43 is made earlier, the ratio of the return stroke during the compression stroke becomes smaller, and the ratio of the discharge stroke becomes larger. As a result, the amount of fuel returned to the low-pressure fuel suction passage 10d decreases, and the amount of fuel discharged at a high pressure increases. On the other hand, if the timing of energizing the electromagnetic coil 43 is delayed, the ratio of the return stroke during the compression stroke becomes larger, and the ratio of the discharge stroke becomes smaller. As a result, the amount of fuel returned to the low-pressure fuel suction passage 10d increases, and the amount of fuel discharged at a high pressure decreases. As described above, by controlling the timing of energizing the electromagnetic coil 43, the amount of fuel discharged at high pressure can be controlled to an amount required by an engine (internal combustion engine).

### 2. Configuration of Retainer

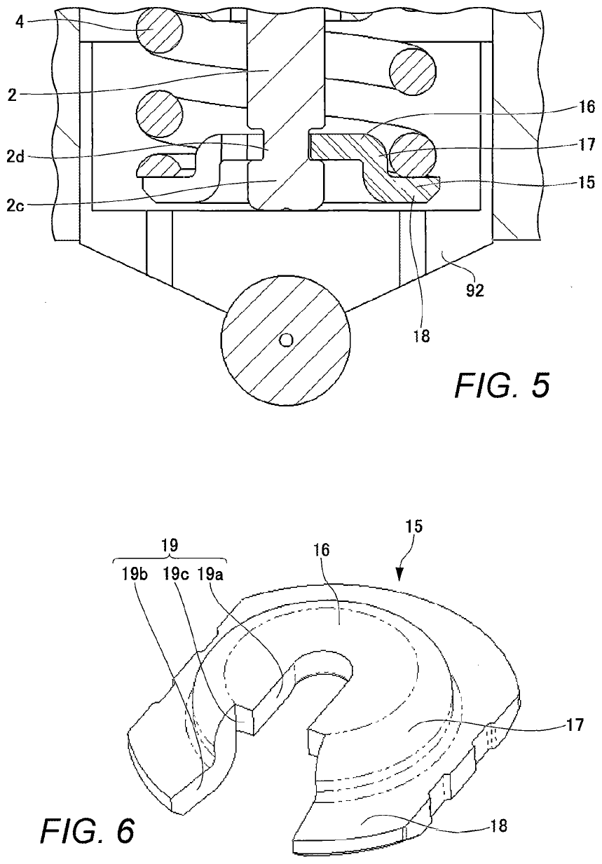

Next, a detailed configuration of the retainer 15 will be described with reference to FIGS. 5 to 12A.

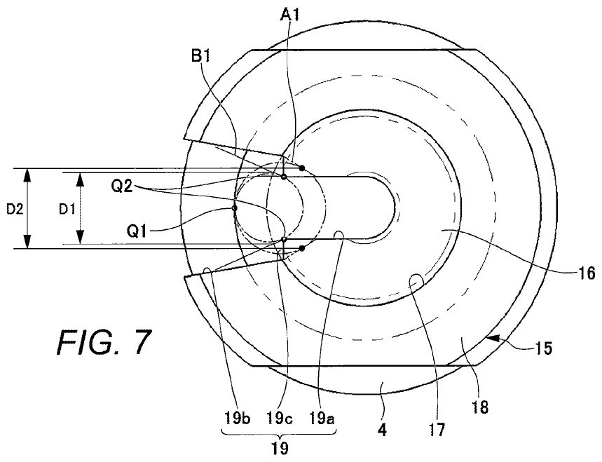

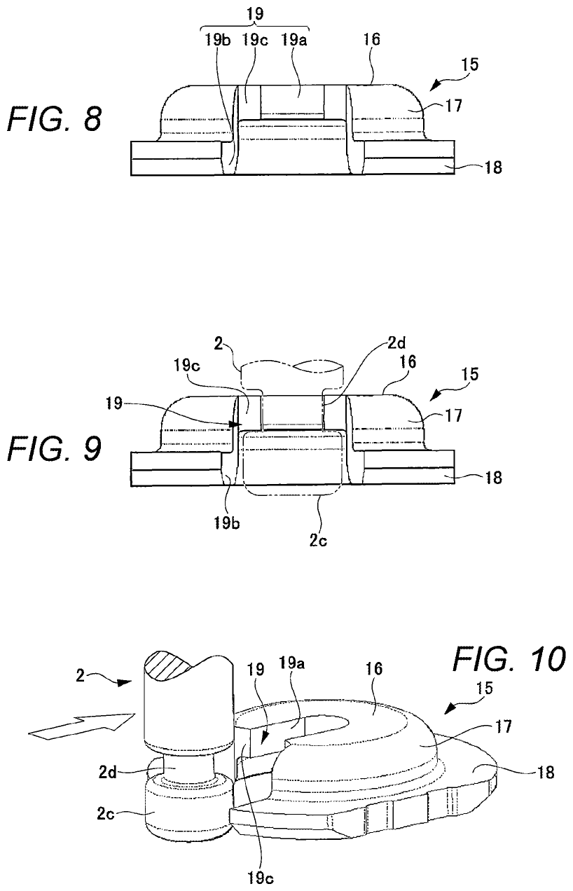

FIG. 5 is an enlarged cross-sectional view of the retainer 15 and the plunger 2, and FIG. 6 is a perspective view of the retainer 15. FIG. 7 is a plan view of the retainer 15, and FIG. 8 is a front view of the retainer 15.

Here, as illustrated in FIG. 5, a constricted portion 2d is formed at a lower end portion 2c in an axial direction of the plunger 2. The lower end portion 2c abuts on the tappet 92. The constricted portion 2d is formed closer to the small diameter portion 2b than the lower end portion 2c. A diameter of the constricted portion 2d is smaller than a diameter of the lower end portion 2c. The retainer 15 is attached to the lower end portion 2c of the plunger 2.

As illustrated in FIG. 6, the retainer 15 includes a flat portion 16 formed in a substantially disk shape, a stepped portion 17, and a flange portion 18. The stepped portion 17 is formed continuously from an outer edge portion of the flat portion 16 on the outer side in a radial direction. The stepped portion 17 is bent substantially perpendicularly from an outer edge portion of the flat portion 16. The flange portion 18 is continuously provided at an end portion of the stepped portion 17 on the side opposite to the flat portion 16. The flat portion 16 and the flange portion 18 are connected by the stepped portion 17. The flange portion 18 is bent substantially perpendicularly from the stepped portion 17. Then, the flange portion 18 and the flat portion 16 are arranged substantially parallel to each other.

As illustrated in FIG. 5, a lower end portion of the spring 4 is placed on the flange portion 18. Then, the flat portion 16 and the stepped portion 17 are inserted into the spring 4. At this time, the stepped portion 17 faces an inner peripheral wall of the spring 4.

Further, on the retainer 15, a mounting portion 19 to be mounted on the lower end portion 2c of the plunger 2 is formed. The mounting portion 19 is formed by continuously notching from an outer edge portion of the flange portion 18 to a center portion of the flat portion 16. The mounting portion 19 includes an engagement portion 19a, a guide portion 19b, and a connection portion 19c that connects the engagement portion 19a and the guide portion 19b.

The engagement portion 19a is continuously formed linearly from an outer edge portion to a center portion of the flat portion 16. A width of an opening of the engagement portion 19a is smaller than the diameter of the lower end portion 2c of the plunger 2. The constricted portion 2d of the plunger 2 is engaged with the engagement portion 19a. The connection portion 19c is continuously formed from an outer edge portion of the flat portion 16 in the engagement portion 19a. As illustrated in FIGS. 7 and 8, the connection portion 19c is formed at a right angle with respect to a linear portion of the engagement portion 19a toward a center portion of the flat portion 16. Then, the connection portion 19c is formed on the flat portion 16 that is flush with the engagement portion 19a.

The guide portion 19b is formed continuously from an outer edge portion of the flange portion 18 to a part of the stepped portion 17, and is continuous with the connection portion 19c. Then, the guide portion 19b guides the constricted portion 2d to the engagement portion 19a when the retainer 15 is mounted on the plunger 2. Further, the guide portion 19b is formed in a tapered shape in which the width of an opening of the guide portion 19b increases from the stepped portion 17 toward an outer edge portion of the flange portion 18. Then, a width of the opening of the guide portion 19b is set to be larger than the diameter of the lower end portion 2c of the plunger 2.

Note that, by forming the guide portion 19b in a tapered shape, the plunger 2 can be smoothly inserted when the plunger 2 is inserted into the mounting portion 19 of the retainer 15. Note that, although the example in which the guide portion 19b is formed in a tapered shape is described, the present invention is not limited to this configuration, and the guide portion 19b may be formed in a linear shape. At least the width of the opening of the guide portion 19b only needs to be larger than the diameter of the lower end portion 2c of the plunger 2.

As illustrated in FIG. 7, a diameter D1 of a circle formed by a corner portion of the engagement portion 19a, that is, two end portions Q2 of the engagement portion 19a on the connection portion 19c side and a point Q1 of an inner peripheral wall of the spring 4 at which the plunger 2 comes into contact is formed to be smaller than the diameter of the lower end portion 2c of the plunger 2. By the above, disengagement between the engagement portion 19a and the constricted portion 2d of the plunger 2 can be prevented, and the retainer 15 can be prevented from falling off the plunger 2.

Note that, although the example in which the connection portion 19c is formed at a right angle with respect to the engagement portion 19a and is formed on the flat portion 16 which is flush with the engagement portion 19a is described, the present invention is not limited to this configuration, and the connection portion 19c may be formed in a tapered shape and extended to the flange portion 18.

Here, as indicated by an alternate long and short dash line A1 in FIG. 7, in a case where the connection portion 19c is formed in a tapered shape, a diameter D2 of a circle formed by the connection portion 19c and an inner peripheral wall of the spring 4 becomes large. For this reason, the retainer 15 may fall off the plunger 2. On the other hand, by forming the connection portion 19c formed at an end portion of the engagement portion 19a at a right angle with respect to the engagement portion 19a, the diameter D1 of a circle formed by a corner portion of the engagement portion 19a and an inner peripheral wall of the spring 4 can be reduced.

Further, as indicated by a line B1, in a case where the connection portion 19c is formed in a tapered shape and extended to the stepped portion 17 and the flange portion 18, the diameter of a circle formed by a corner portion of the engagement portion 19a and an inner peripheral wall of the spring 4 can be made smaller than the diameter of the lower end portion 2c. However, the width of the opening of the guide portion 19b becomes small, the lower end portion 2c interferes with the guide portion 19b or the connection portion 19c, the assemblability is deteriorated, or the retainer 15 cannot be attached to the plunger 2.

FIGS. 9 and 10 are diagrams illustrating a state in which the retainer 15 is attached to the plunger 2. By forming the connection portion 19c formed at an end portion of the engagement portion 19a at a right angle with respect to the engagement portion 19a and forming the connection portion 19c on the same flat portion 16 as the engagement portion 19a, as illustrated in FIG. 9, the width of the opening of the guide portion 19b can be ensured to be sufficiently larger than the diameter of the lower end portion 2c. By the above, as illustrated in FIG. 10, the plunger 2 can be inserted into the mounting portion 19 of the retainer 15 from a lateral direction orthogonal to the axial direction of the plunger 2. As a result, the retainer 15 can be easily attached to the plunger 2.

As described above, the connection portion 19c may be formed in a tapered shape and extended to the flange portion 18, but the connection portion 19c is preferably formed at a right angle with respect to the engagement portion 19a and formed on the flat portion 16 which is flush with the engagement portion 19a.

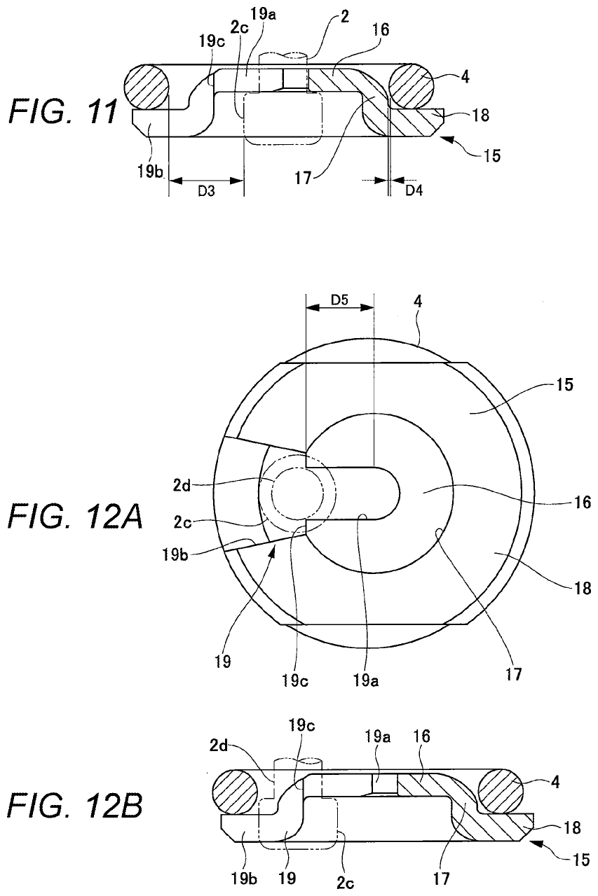

FIG. 11 is a cross-sectional view illustrating a relationship of a gap between the retainer 15, the plunger 2, and the spring 4. As illustrated in FIG. 11, a gap D3 between the lower end portion 2c of the plunger 2 and an inner peripheral wall of the spring 4 is an amount of eccentricity generated between the plunger 2 and the spring 4. Further, when the plunger 2 abuts on the spring 4, the inner peripheral wall of the spring 4 abuts on an outer peripheral surface of the stepped portion 17 of the retainer 15. Then, a gap D4 between the inner peripheral wall of the spring 4 and the outer peripheral surface of the stepped portion 17 of the retainer 15 is the amount of eccentricity of the retainer 15 with respect to the spring 4. For this reason, a maximum amount of eccentricity of the retainer 15 with respect to the plunger 2 is a total length of the gap D3 and the gap D4.

FIGS. 12A and 12B are diagrams illustrating a state in which the retainer 15 is eccentric.

As illustrated in FIG. 12A, a length of a linear portion of the engagement portion 19a, that is, a length D5 from a center portion of the flat portion 16 to the connection portion 19c is a length by which the engagement portion 19a can be engaged with the constricted portion 2d. The length D5 of the engagement portion 19a is set to be longer than the total length of the gap D3 and the gap D4. For this reason, as illustrated in FIGS. 12A and 12B, when the retainer 15 is maximally eccentric, the engagement portion 19a of the retainer 15 abuts on the lower end portion 2c of the plunger 2. This makes it possible to prevent the retainer 15 from falling off the plunger 2 also before the retainer 15 is accommodated in the tappet 92.

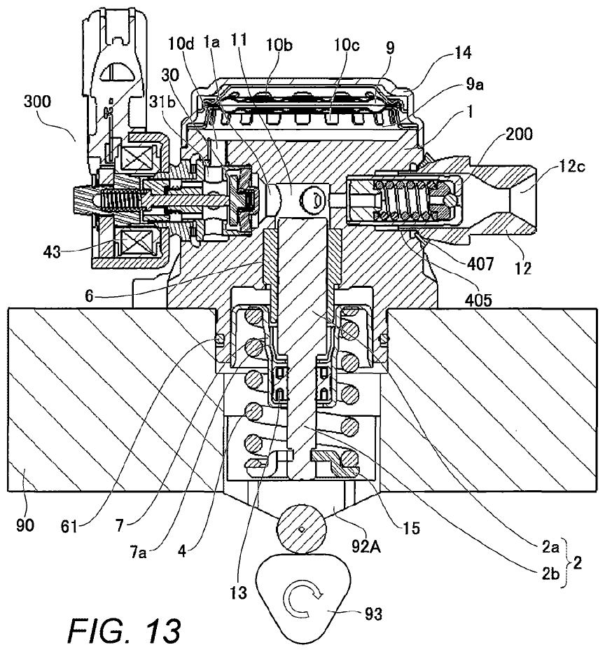

FIG. 13 is a longitudinal cross-sectional view illustrating another example of the high-pressure fuel pump.

In the high-pressure fuel pump illustrated in FIG. 13, a tappet 92A is larger than the tappet 92 illustrated in FIG. 2. For this reason, a larger gap than that in the example illustrated in FIG. 2 is formed between the tappet 92A and the retainer 15. However, as described above, the retainer 15 of the present embodiment does not fall off the plunger 2 also before being accommodated in the tappets 92 and 92A.

By the above, the same retainer 15 can be used for the tappets 92 and 92A having different sizes without newly designing the retainer 15. As a result, also in a case where the tappet has a large size due to a customer request for higher fuel pressure and a gap between the retainer 15 and the tappet becomes large, it is possible to share a component, and development man-hours and cost can be greatly reduced.

The embodiment of the fuel pump of the present invention is described above together with an operational effect of the embodiment. However, the fuel pump of the present invention is not limited to the above-described embodiment, and various variations can be made without departing from the gist of the invention described in the claims. Further, the above embodiment is described in detail for easy understanding of the present invention, and the present invention is not necessarily limited to one that includes all the described configurations.

### REFERENCE SIGNS LIST

1 pump body
1a suction passage
1c fixing portion
1e flange
2 plunger
2a large diameter portion
2b small diameter portion
2c lower end portion
2d constricted portion
4 spring
6 cylinder
7 seal holder
7a auxiliary chamber
8 discharge valve mechanism
9 pressure pulsation reduction mechanism
10 low-pressure fuel chamber
11 pressurizing chamber
12 discharge joint
12a discharge valve chamber
12b discharge passage
15 retainer
16 flat portion
17 stepped portion
18 flange portion
19 mounting portion
19a engagement portion
19b guide portion
19c connection portion
20 fuel tank
21 feed pump
23 common rail
24 injector
26 fuel pressure sensor
27 ECU
28 fuel pipe
30 suction valve
31 suction valve seat
32 stopper
33 suction valve biasing spring
40 rod biasing spring
41 on-off valve biasing spring
92, 92A tappet
93 cam
100 high-pressure fuel pump
200 relief valve mechanism
300 electromagnetic suction valve mechanism

1. A fuel pump comprising:
a plunger that reciprocates;
a retainer having a mounting portion mounted on a lower end portion of the plunger; and
a spring that biases the plunger via the retainer,
wherein
the mounting portion of the retainer has an engagement portion that is engaged with a constricted portion formed at the lower end portion of the plunger, and
a diameter of a circle formed by a corner portion of the engagement portion and an inner peripheral wall of the spring is smaller than a diameter of the lower end portion of the plunger.

2. The fuel pump according to claim 1, wherein
the mounting portion includes a guide portion that guides the constricted portion toward the engagement portion, and
a length of a width of an opening in the guide portion is larger than a diameter of the lower end portion of the plunger.

3. The fuel pump according to claim 2, wherein
the retainer includes
a flat portion on which the engagement portion is formed,
a stepped portion continuous from an outer edge portion of the flat portion, and
a flange portion which is continuous from an end portion of the stepped portion on a side opposite to the flat portion and on which the spring is placed, and
the guide portion is formed in the flange portion.

4. The fuel pump according to claim 3, wherein the mounting portion includes a connection portion that connects the engagement portion and the guide portion.

5. The fuel pump according to claim 4, wherein
the engagement portion is formed linearly from a center portion to an outer edge portion of the flat portion, and
the connection portion is formed at a right angle with respect to the engagement portion.

6. The fuel pump according to claim 4, wherein the connection portion is formed on the flat portion that is flush with the engagement portion.

7. The fuel pump according to claim 3, wherein
the flat portion and the stepped portion are inserted into the spring, and
a length of the engagement portion engageable with the constricted portion is set to be longer than a total length of a gap between the lower end portion of the plunger and an inner peripheral wall of the spring and a gap between the inner peripheral wall of the spring and an outer peripheral surface of the stepped portion.
